(19) United States
(12) Patent Application Publication
(10) Pub. No.: US 2014/0249965 A1
(43) Pub. Date: Sep. 4, 2014

(54) MEDIA ITEM COLLECTION PRE-ORDER FULFILLMENT

(71) Applicant: APPLE INC., Cupertino, CA (US)

(72) Inventors: Farman A. Syed, San Jose, CA (US); Tara Uyeyama, Cupertino, CA (US); David Neumann, Lake Oswego, OR (US); Alan Yu, Vancouver (CA); Michael H. Schrag, Richmond, VA (US); David Makower, Milpitas, CA (US); Tracy Pirnack, Los Altos, CA (US); Jill Harwell, Mountain View, CA (US); Jay Liepis, Campbell, CA (US); Jonathan B. Leffert, Redwood, CA (US); Elizabeth Trumbull, San Jose, CA (US); Jonathan M. Lee, Sunnyvale, CA (US); Mufaddal Y. Khumri, Campbell, CA (US)

(73) Assignee: Apple Inc., Cupertino, CA (US)

(21) Appl. No.: 13/783,099

(22) Filed: Mar. 1, 2013

(51) Int. Cl. G06Q 30/06

(52) U.S. Cl. CPC G06Q 30/0635
USPC 705/26.81

(57) ABSTRACT

Fulfilling a pre-order for a collection of media items in an online store, enforcing one or more pricing schemes which adjust the price charged for the collection of media items purchased as a pre-order, and managing changes to a pre-order campaign as they are received from a media publisher.

### BACKGROUND

1. Technical Field

The present disclosure relates to digital media item pre-orders and more specifically to completion a pre-order and accounting for previously purchased individual early-release media items.

2. Introduction

Digital media stores offer digital goods for purchase, rent, streaming access, etc. Some digital media publishers offer digital goods in a pre-order sale before the actual date that the goods are to be released. Oftentimes, a publisher will incentivize customers to purchase a pre-order collection of digital media items before the actual release of the digital goods by offering the pre-order items at a price point less than the actual release price. However, in some cases, a customer can be charged a second time when purchasing a pre-order collection of digital media items when the customer already owns the rights to one or more digital media item that is the same or similar to media items in the collection available for pre-order. Indeed, this phenomenon of double-charging for same or similar media items discourages customers from purchasing a remainder of a pre-order collection of media items.

Accordingly, there is a need for systems, methods, and computer readable media that incentivize users who purchase individual media items from a pre-order collection of media items to purchase the remaining media in the collection by offering the remaining media items without double charging for those items.

Additionally, known systems for allowing publishers the ability to offer pre-order media items are inflexible. Indeed, known methods of providing pre-order media items do not allow the publisher to make changes to the offered collection of digital media once they are initially published in a pre-order offering. Accordingly, there is an additional need for systems, methods, and computer readable media that allow publisher to roll out and change early release media items in a pre-order collection campaign.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for managing a pre-order campaign of rolling out a collection of media items. Some embodiments of the present technology involve a media distribution platform with an online store management module that receives information from a content provider describing a collection of media items and that schedules when the media items in the collection of media items will be released. The online management module can also schedule a range of dates describing a pre-order period that the collection of media items will be available for pre-order. Additionally, the online store can manage changes to the schedule, thereby offering the content provider flexibility to create a pre-order campaign.

In some embodiments, the online management module can receive an order from a customer for the pre-order collection and charge the customer an amount that is dependent upon the schedule and when the purchase order was submitted. Also, the online management module can receive an indication that a media item from the collection will be offered as an early release media item and can also manage how much to charge a customer purchasing the early release media item according to an honor-pricing schema. Likewise, the online management module is configured to receive additional early release media items after the initial early release item, thereby allowing the content provider to roll out media in any way it deems most advantageous.

In some embodiments, the online management module is configured to receive an original release and a subsequent modified release date. Additionally, the online management module can determine that the modified release date has been moved further into the future than the original release date; and, if the modified release date was received less than a threshold period of time before the original release date, the online management module can send a notification to a customer who ordered the collection of media items in the pre-order period describing the change. Alternatively, if the modified release date was received after a threshold period of time before the original release date, the online management module can begin to toll a waiting period, determine that a subsequent change to the modified release date has not been received during the waiting period, send a notification to a customer who ordered the collection of media items in the pre-order period.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an online store interface in a media distribution platform for offering a collection of media items for pre-order using an honor-pricing schema according to some embodiments of the present technology;

FIG. 2 illustrates an online store interface for allowing users who purchase early release media items to purchase the remainder of the collection of media items at a discounted price according to some embodiments of the present technology;

FIG. 3 illustrates an online store interface for confirming a user's intention to purchase an entire collection of media items upon being released according to some embodiments of the present technology;

FIG. 4 illustrates a method of enforcing a pre-order honor-pricing schema that accounts for the timing of a pre-order price increase and the timing of when a customer orders the collection of media items according to some embodiments of the present technology;

FIG. 5 illustrates a method of enforcing a pre-order honor-pricing schema that accounts for a pre-order price decrease according to some embodiments of the present technology;

FIG. 6 illustrates a method of enforcing a pre-order honor-pricing schema that accounts for the purchase of an early release from a collection of media items available for pre-order according to some embodiments of the present technology;

FIG. 7 illustrates a method of enforcing a pre-order honor-pricing schema that accounts for the purchase of an early release from a collection of media items available for pre-order and that accounts for a pre-order price decrease according to some embodiments of the present technology;

FIG. 8 illustrates a method of determining similarity between previously owned media items for the purpose of determining how much to charge a user upon releasing a collection of pre-ordered media items according to some embodiments of the present technology;

FIG. 9 illustrates a method of rolling out a pre-order campaign according to some embodiments of the present technology;

FIG. 10 illustrates a method of sending pre-order campaign notifications to customers according to some embodiments of the present technology;

FIG. 11A illustrates an application distribution system according to some embodiments of the present technology;

FIG. 11B illustrates a conventional bus computing system architecture according to some embodiments of the present technology; and

FIG. 11C illustrates a computer system having a chipset architecture according to some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

As explained above, there is a need for systems, methods, and computer readable media that incentivize users who purchase individual media items from a pre-order collection to purchase the remaining media in the collection by offering the remaining media items at a discounted price.

### Pre-Order Collection Completion

The present technology involves a media distribution platform offering collections of media items for pre-order in from an online distribution platform via an online media store. For example, the collection of media items can comprise an album available for pre-order from a publisher that will be actually published and released at a later date. A publisher can chose to make an album available for pre-order as a marketing tool for creating a sense of excitement in the fan community. Additionally, to incentivize customers to purchase the album, the publisher will oftentimes price the pre-order at a less expensive price point than that of what the album will retail for on the actual release date.

However, customers are oftentimes reluctant to purchase an album before listening to a released single, before reading reviews about the album, etc. So, to allow a customer the opportunity to sample what will eventually be released in the collection of media items and to further create excitement for an upcoming album release, the publisher will sometimes release one or more media item from the collection before the actual publication date of the full collection.

However, the price of the earlier released media items are typically priced at higher price point than if a user buys an entire album. For example, a collection of media items containing ten individual media items can be offered at $9.99 (or $0.99 per item) while individual early-release media items can be priced at $1.25. In this example, customers purchasing the entire collection save $1.26 over those customers purchasing each of the ten media items individually. However, customers who purchase an early-release media item from the collection and later purchase the entire pre-order collection would be disenfranchised if they had to pay twice for the early-release media item or if they were still charged the higher price for the early released items. Continuing with the previous example, a customer purchasing a single early release media item for $1.25 and the remaining nine media items at the pre-order price of $0.99 would be charged $10.24 instead of the $9.99 album pre-order price. Indeed, this pricing scheme would be a disincentive to customers to purchase individual early release media items from a collection of pre-order media. Accordingly, some embodiments of the present technology involve a pre-order completion system that includes an honor-pricing schema.

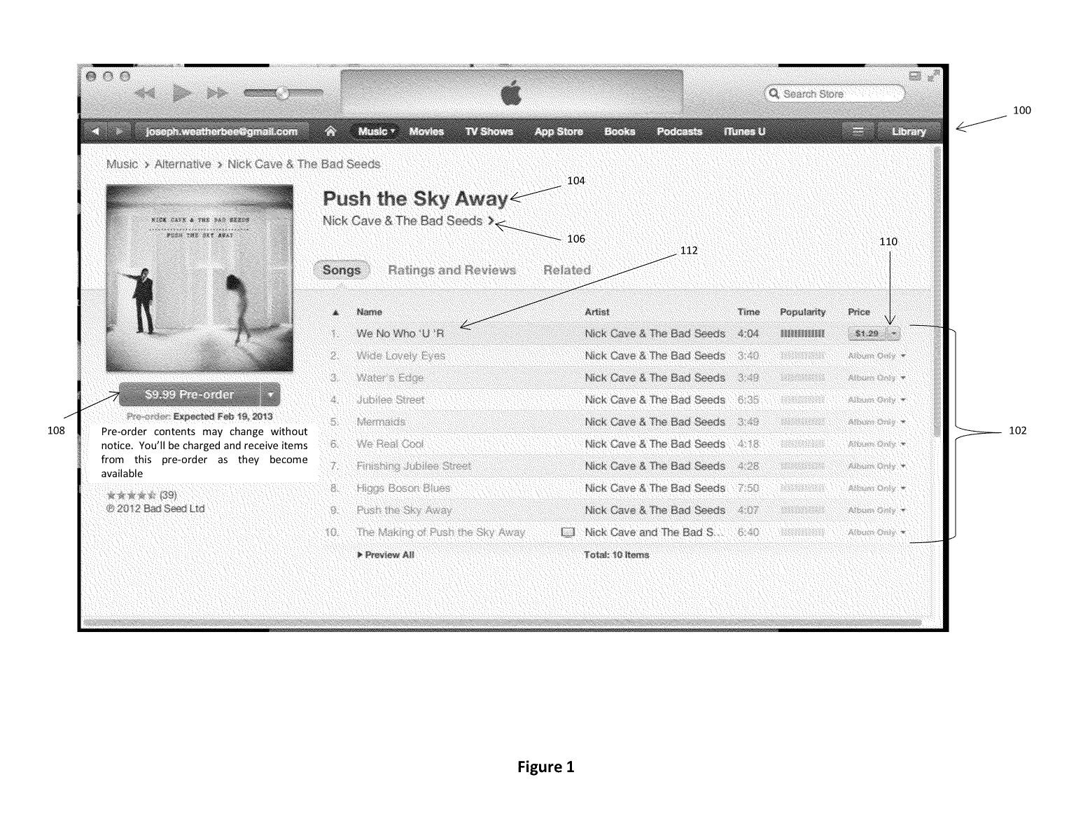

FIG. 1 illustrates an exemplary store interface 100 for a media distribution platform offering a collection of media items 102 for pre-order and using an honor-pricing schema. According to some embodiments of the present technology, the collection of media items 102 comprises an album 104 that is available for pre-order from a publisher 106 and that is priced at a pre-order price. The interface 100 includes a collection purchase tool 108 for allowing a user to purchase the collection of media items 102 at the pre-order price. Additionally, the interface 100 includes an early release media item purchase tool 110 for allowing a user to purchase an individual early release media item 112 before the actual release date of the full collection of media items 102.

As explained above, to avoid discouraging users from purchasing individual early release media items from the collection of media items 102, the present technology involves one ore more honor-pricing scheme (explained in more detail below) that allow users to purchase the remainder of the collection of media items 102 at a discounted price.

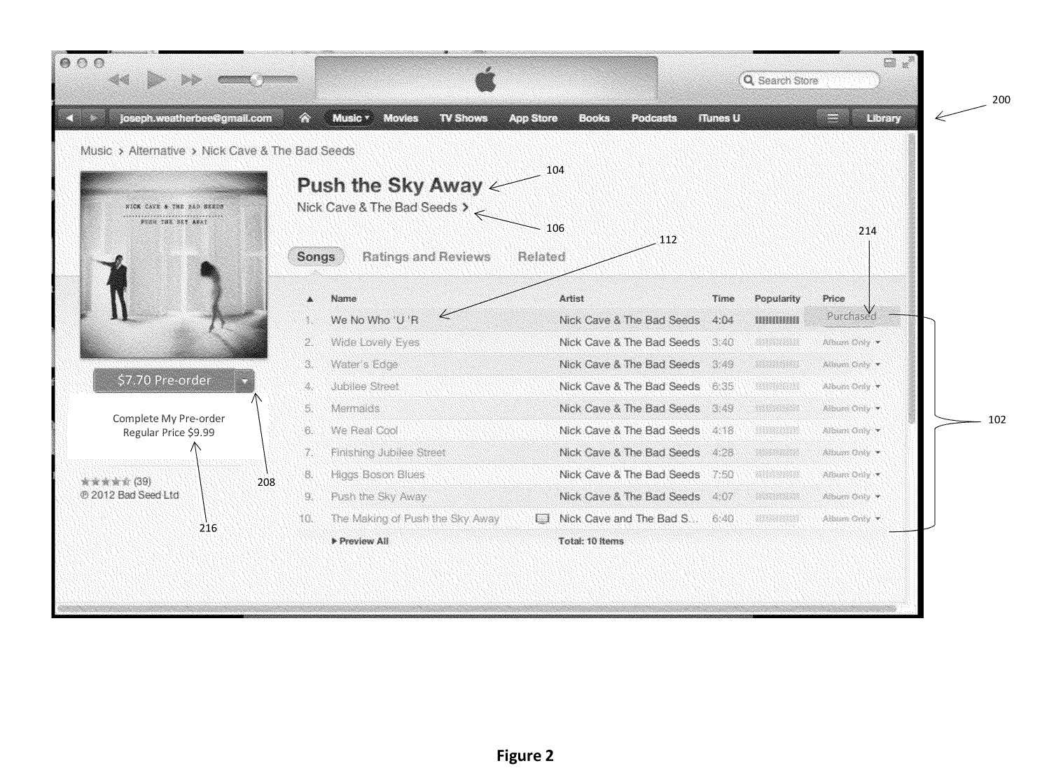

FIG. 2 illustrates an interface 200 for allowing users who purchase early release media items to purchase the remainder of the collection of media items 102 at a discounted price. The interface 200 of FIG. 2 represents an interface viewed subsequent to a user purchasing an individual early release media item 112 with the early release media item with purchase tool 110 before the actual release date of the full collection of media items 102. Notably, the interface 200 now includes a collection remainder purchase tool 208 for allowing a user to purchase the remainder of collection of media items 102 at a price equal to an initial pre-order price for the full collection of media items 102 minus the price of the previously purchased individual early release media item 112. Likewise, the early release media item purchase tool 110 is replaced with a notification 214 that the individual early release media item 112 has been purchased and a pre-order price reminder notification 216.

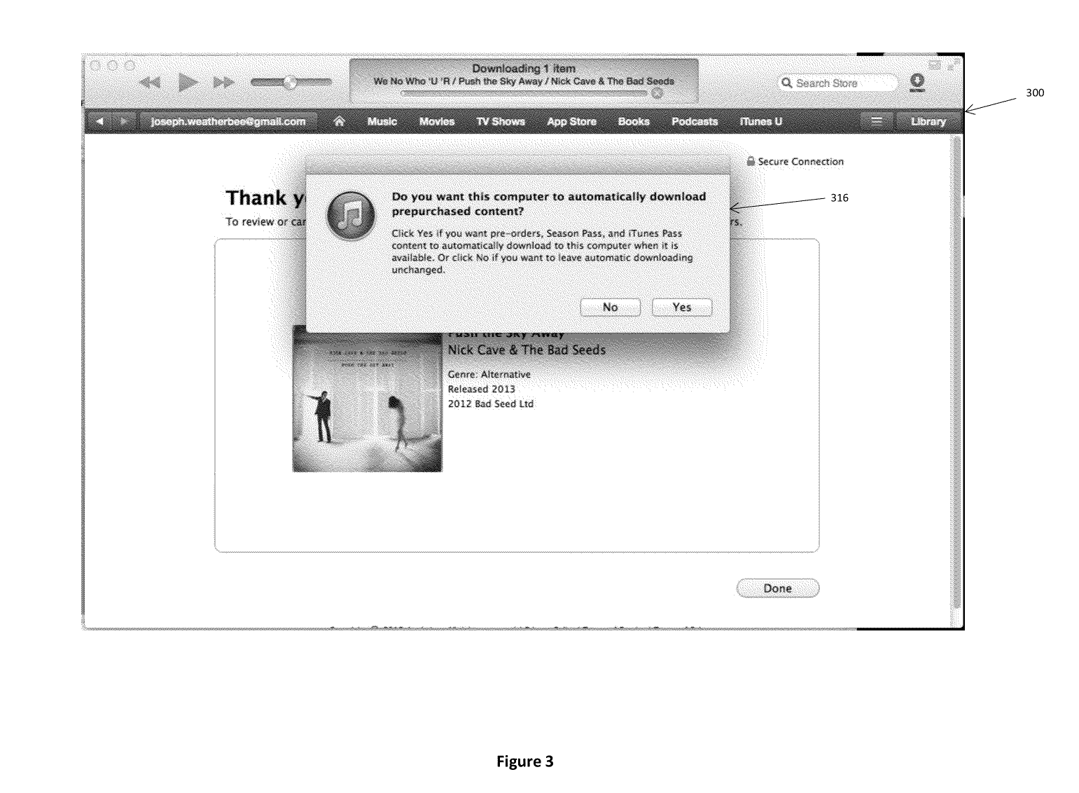

The collection remainder purchase tool 208, as well as the collection purchase tool 108, allows a user to purchase the entire collection of media items 102. FIG. 3 illustrates an exemplary interface 300 confirming that the user has indicated an intention to purchase the entire collection of media items 102 upon being released as well as a notification tool 316 for allowing the user to indicate whether he wants to automatically download the remaining media items in the collection of media items 102 upon its actual release.

Additionally, in some embodiments of the present technology, a pre-order management interface is configured to view the status (release date, early release media item, etc.) of pre-orders collections and to cancel a pre-order any time before the actual release date.

### Honor-Pricing Schemes

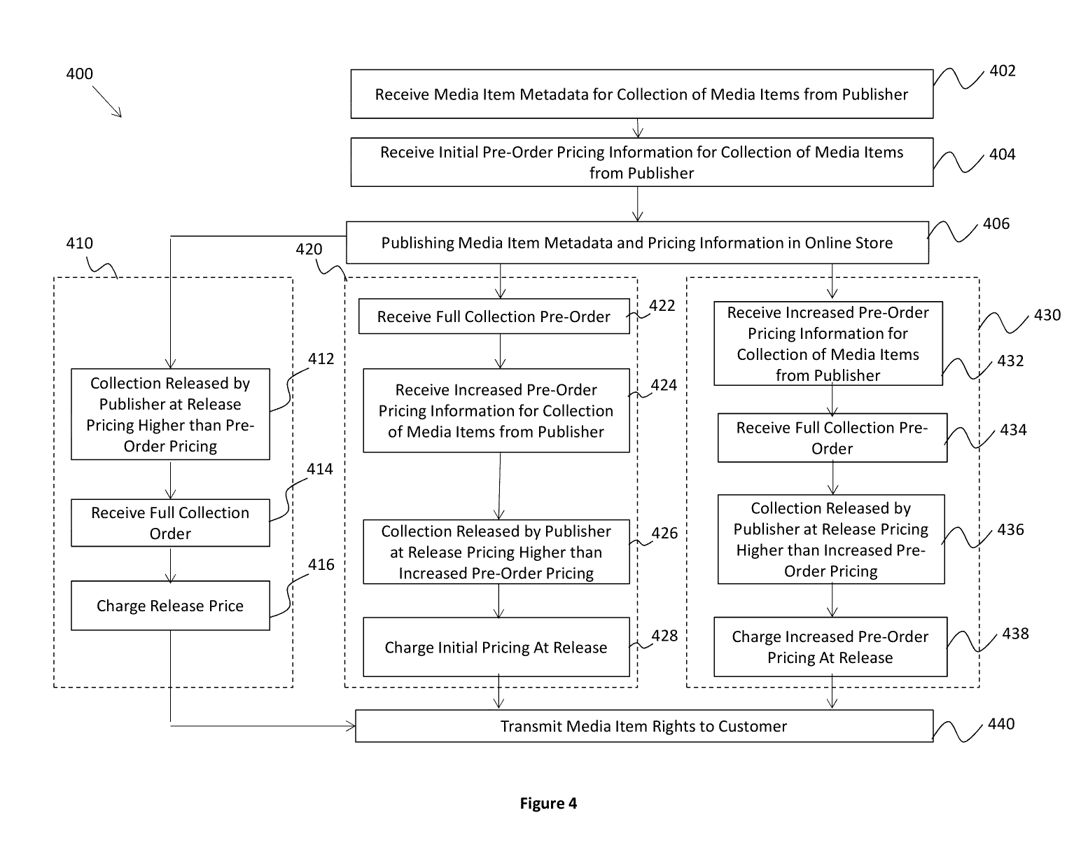

As explained above, some embodiments of the present technology involve a pre-order completion system that utilizes one ore more honor-pricing scheme. FIGS. 4-7 illustrate methods of enforcing pre-order honor-pricing schemes according to some embodiments of the present technology.

In some embodiments, the pre-order honor-pricing schemes also take into account a variable pre-order price point. Sometimes, to encourage customers to pre-order a collection of media items when the pre-order is initially announced and published, the publisher of the collection of media can decide to increase the pre-order price of the collection of media items before it is released. For example, a collection of media items can initially be released for pre-order at a price point of $9.99. Later, the collection of pre-order media items can be priced at $12.99 with the eventual price of the collection at the time of release being $14.99. In these scenarios, the honor-pricing schema factors in when a customer pre-orders the collection to determine the price points for the collection of media items at the time of release.

FIG. 4 illustrates an exemplary method 400 of enforcing a pre-order honor-pricing schema that accounts for the timing of a pre-order price increase and at the time a customer orders the collection of media items. In some embodiments, the method 400 is performed in a media distribution platform and begins with receiving media item metadata (e.g. artist name, album name, track titles, etc.) for a collection of media items from a publisher 402 and receiving initial pre-order pricing information for the collection of media items from the publisher 404. Next, the online store publishes the media item metadata and pricing information 406.

After the pre-order is published, the method 400 involves three scenarios 410, 420, 430. According to the first scenario 410, a pre-order is not purchased and the collection of media items is released at a release price point that is higher than the pre-order pricing 412. Upon the receipt of an order from a customer for the full collection of media items 414, the online store charges the customer the release price 416 and transmits the rights to the media items to the customer 440.

As used herein, transferring the rights to the digital media items can comprise actually delivering digital media items themselves or storing an indication in the digital media platform that the user is entitled to download, stream, etc. the digital media at a later time.

According to the second scenario 420, a customer submits, and the online store receives, an order for the full collection of media items on pre-order 422, but the customer is not charged at that time. Subsequently, the store receives increased pre-order pricing information for the collection of media items from the publisher 424. At a later point in time, the collection is published as a full (non-pre-order) release through the online store at a price point even higher than the increased pre-order price 426. In the second scenario 420, since the customer ordered the collection as a pre-order before the pre-order price rose before the release of the pre-order, the store charges the customer the initial pre-order price 428 and transmits the rights to the media items to the customer 440.

In the third scenario 430, the store receives increased pre-order pricing information for the collection of media items from the publisher 432 before a customer submits, and the online store subsequently receives an order for the full collection of media items on pre-order 434. The collection is later released through the online store at a price point even higher than the increased pre-order price 436. In this third scenario, since the customer ordered the pre-order after the pre-order price rose, but before the release of the pre-order, the stores charges the customer the increased pre-order price 438 and transmits the rights to the media items to the customer 440.

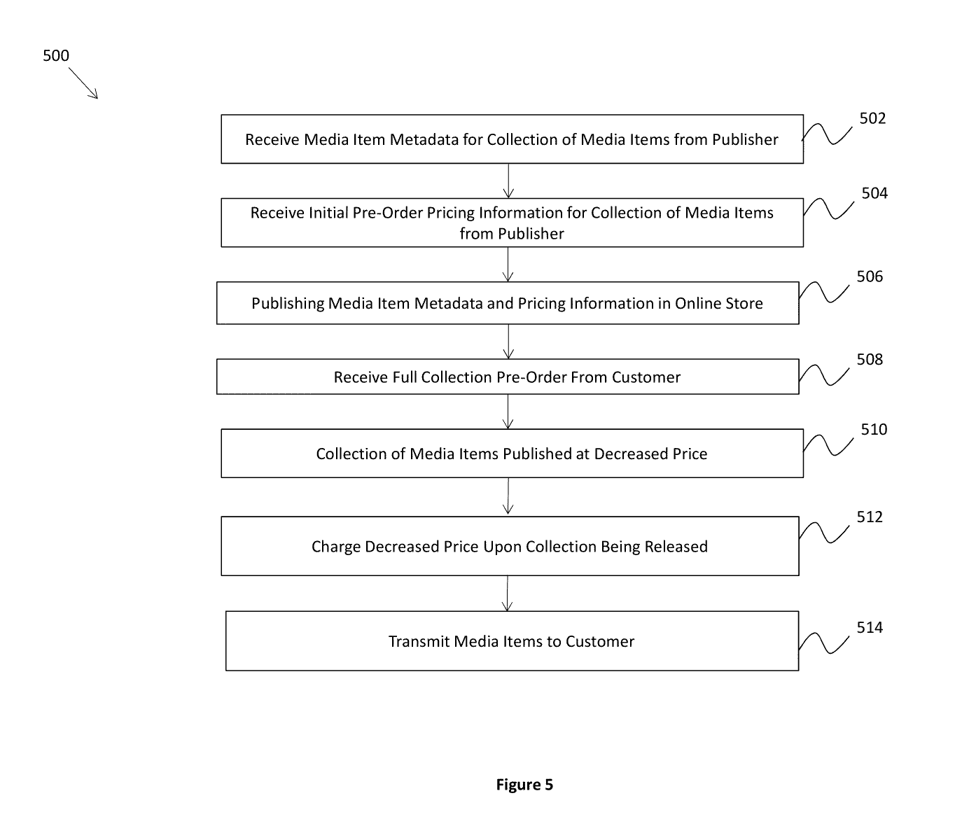

FIG. 5 illustrates an exemplary method 500 for enforcing a pre-order honor-pricing schema that accounts for a pre-order price decrease. In some embodiments, the method 500 is performed in a media distribution platform and begins with receiving media item metadata (e.g. artist name, album name, track titles, etc.) for a collection of media items from a publisher 502 and receiving initial pre-order pricing information for the collection of media items from the publisher 504. Next, the method 500 involves the online store publishing the media item metadata and pricing information 506.

The schema continues with a customer submitting, and the online store receiving, an order for the full collection of media items on pre-order. Subsequently, the collection is released through the online store at a decreased price point from that of the pre-order price 510. In some situations, the pre-order honor-pricing schema can dictate that the store charges the customer the decreased price 512 and transmits the rights to the media items to the customer 514.

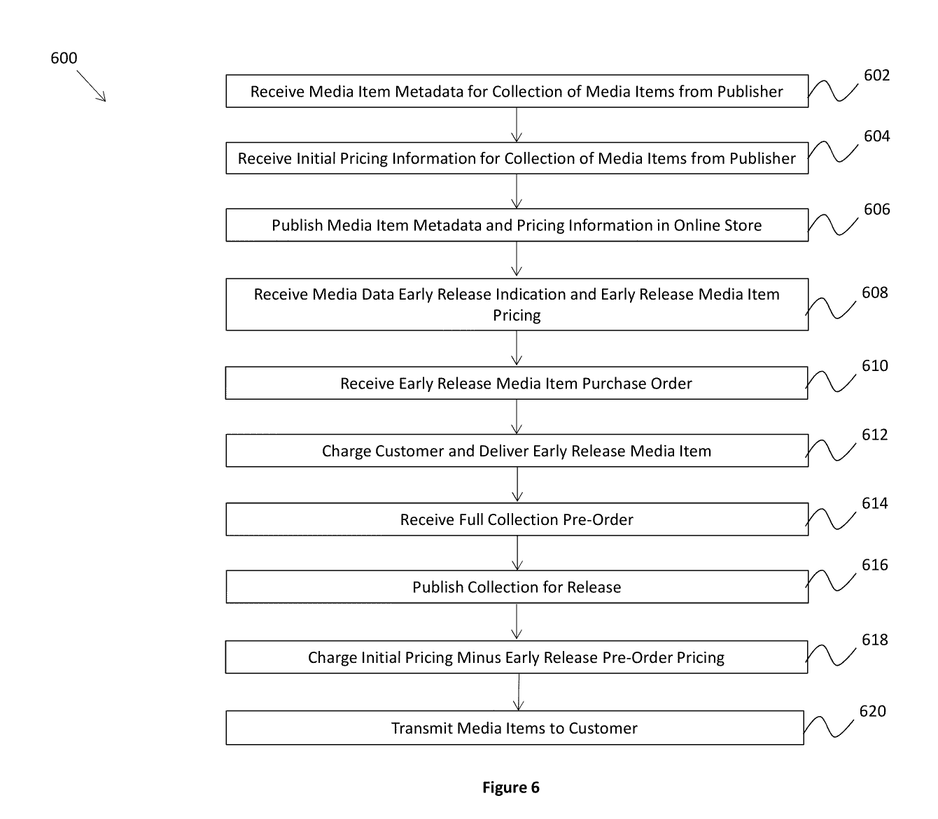

FIG. 6 illustrates an exemplary method 600 of enforcing a pre-order honor-pricing schema that accounts for the purchase of an early release from a collection of media items available for pre-order. In some embodiments, the method 600 is performed in a media distribution platform and begins with receiving media item metadata for a collection of media items from a publisher 602 and receiving initial pre-order pricing information for the collection of media items from the publisher 604. Then, the online store publishes the media item metadata and pricing information 606.

Next, the media distribution platform receives both an indication from the publisher that one or more of the media items in the collection is to be released as an early release as well as pricing information for the early release item 608. Next, the media distribution platform receives a purchase order for the early release media item 610 and charges the customer according to the pricing information and delivers the rights to the early release media item to the customer 612.

Subsequently, the customer submits, and the online store receives, an order for the full collection of media items on pre-order 614. Later, when the collection is published and offered for sale through the online store 616, the honor-pricing schema can dictate that the store charge the customer the initial pricing minus the already-charged pricing information for the early release item 618 and transmits the rights to the media items to the customer 620.

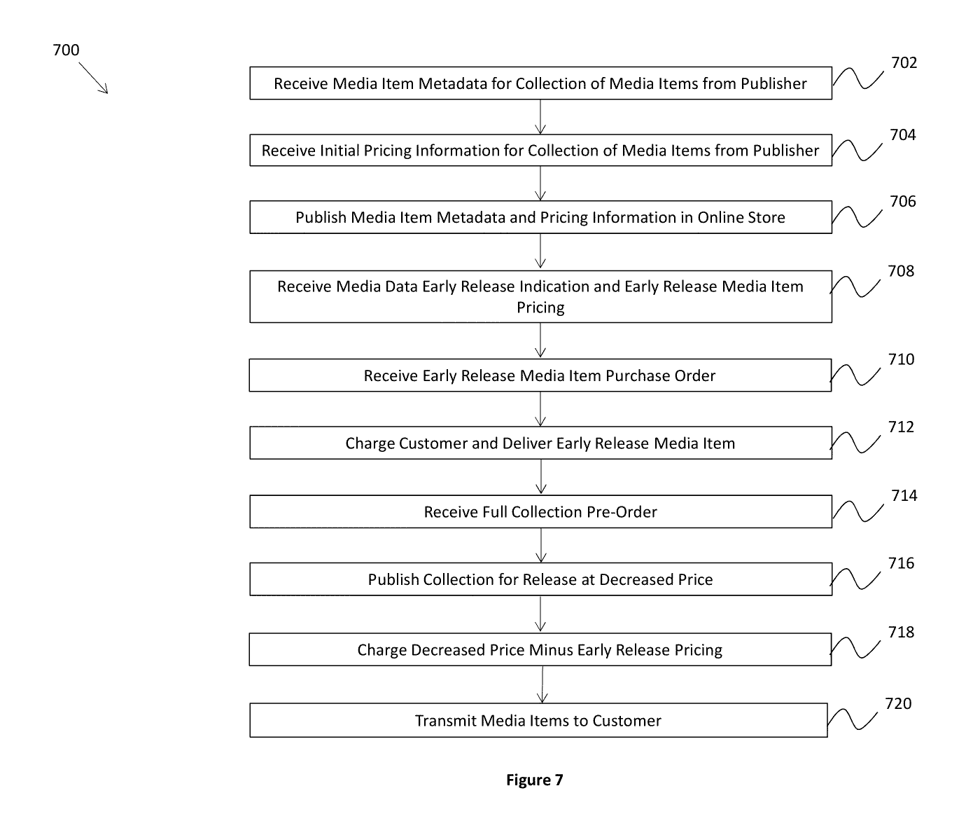

FIG. 7 illustrates an exemplary method 700 for enforcing a pre-order honor-pricing schema that accounts for the purchase of an early release from a collection of media items available for pre-order and accounts for a pre-order price decrease. In some embodiments, the method 700 begins with receiving media item metadata for a collection of media items from a publisher 702 and receiving initial pre-order pricing information for the collection of media items from the publisher 704. Next, the online store publishes the media item metadata and pricing information 706.

The media distribution platform then receives an indication from the publisher that one or more of the media items in the collection is to be released as an early release along with pricing information for the early release item 608. Next, the media distribution platform receives a purchase order for the early release media item 610 from the customer, charges the customer according to the pricing information, and delivers the rights to the early release media item to the customer 612.

Subsequently, the customer submits, and the online store receives, an order for the full collection of media items on pre-order 614. Later, if the collection is published and offered for sale at a decreased price through the online store 716, the honor-pricing schema can dictate that the store charge the customer the decreased price minus the already-charged pricing information for the early release item 718 and can transmit the rights to the media items to the customer 720.

### Providing Credit for Items in Library Having Threshold Similarity to Items in Pre-Order Collection

In the methods discussed above, the pre-order honor-pricing schemes adjust the pricing of a collection of pre-order media items to account for price increases, price decreases, early release media items purchased from the pre-order collection, etc. Some embodiments of the present technology also involve systems and methods for adjusting the pricing of a collection of pre-order media items based on the customer already having, in a digital media library, a media item having threshold similarity to a media item in the pre-order collection.

In an illustrative example, consider a customer who is a devoted fan to a particular artist and who owns many of the artist's previously released media items. Suppose the same artist releases a “Greatest Hits” collection of media items for pre-order that includes media that is the same or similar to previously-released media items, but also some new media items. According to the present technology, if the fan pre-orders the collection, the system can determine that the fan already possess media that is the same or similar to one or more of the previously-released media items in the collection and, upon release, charge the fan the pre-order price minus the price of the media items already possessed by the fan.

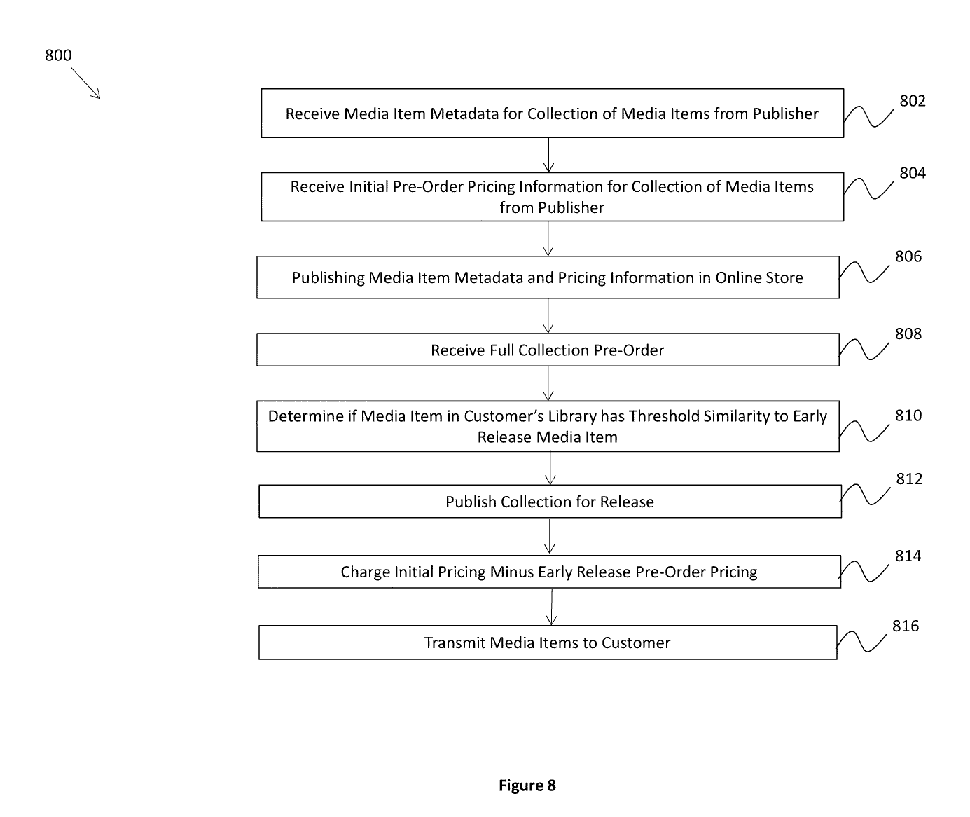

FIG. 8 illustrates a method 800 of determining similarity of previously owned media items for the purpose of determining how much to charge a user upon releasing a collection of pre-ordered media items according to some embodiments of the present technology. In some embodiments, the method 800 involves receiving media item metadata (e.g. artist name, album name, track titles, etc.) for a collection of media items from a publisher 802 and receiving initial pre-order pricing information for the collection of media items from the publisher 804. The online store then publishes the media item metadata and pricing information 806.

Next, the media distribution platform receives an order for the full collection of media items on pre-order 808, but the customer is not charged at that time. Later, when the collection is published through the online store 810, the method 800 involves determining whether one or more media items in the customer's library have a threshold similarity to a media item in the collection 812.

The method 800 continues with invoking an honor-pricing schema dictating that the store charge the customer the pre-order price minus the price of the media items in the collection found to possess a threshold similarity to a customer's library media items 814. Finally, the media distribution platform transmits the rights to the media items to the customer 816.

The determination whether a media item is similar to another media item in a pre-order can involve various tactics. In some embodiments, an online store or media distribution system can compare metadata of each of the media items and determine if the metadata has a threshold similarity. In some cases, links are manually created between online store item identifiers such that threshold similarity is automatically determined when viewing a pre-order collection. In some embodiments, a threshold similarity determination can be made by performing an audio signal analysis on media items, or by other audio analysis techniques.

In another example, a publisher of a song can publish the media collection and ask the media distribution platform to give a customer credit for previously owned music tracks with a performance of a song by a performer as on the new collection even if the song is performance in a different context or venue (e.g., live versus studio recordings.) In such embodiments, this can be accomplished by specifying the similarity rules to indicate how much of the metadata of a previously owned track must match the metadata of a track in the new collection. For example, similarity rules can specify that a total number of metadata items must match. In another example, the similarity rules can specify that specific metadata match or at least have a degree of similarity above a threshold value. In still another example, the similarity rules can specify that for certain metadata values will be considered equivalent. In some cases, the media distribution can enforce different similarity rules based on date, time, user characteristics, user device, and/or other factors; and, in those cases, the media distribution platform can decide which set of rules to default to. Alternatively, the media distribution platform can select the similarity rules based on its own criteria.

### Pre-Order Countdown Campaign

As explained above, there is a need for allowing publisher to roll out early release media items in a pre-order collection campaign. Accordingly, some embodiments of the present technology involve systems, methods, and computer readable media that allows publishers to schedule the availability of a plurality of early release media items in a single pre-order collection of media items at different times. Further, customers who purchase the pre-order collection can be charged and receive the early release media items as soon as they are rolled out by the publishers.

A media distribution platform can be configured for allowing publishers to schedule an early release campaign with media items being released on different dates to build community excitement for the full collection. Also, sometimes a publisher will not be aware that a particular media item in a collection will be in high demand. For example, if a particular media items gains rapid unexpected popularity, the publisher can decide to feature the media item as an early release from the collection to market the full collection.

Additionally, the media distribution platform can be configured to allow publishers to schedule a media item to be released in a pre-order collection in two geographical areas at two different times. Also, in some embodiments, the media distribution platform can be configured to allow publishers to change the order of media items in a pre-order collection before the actual release date of the collection.

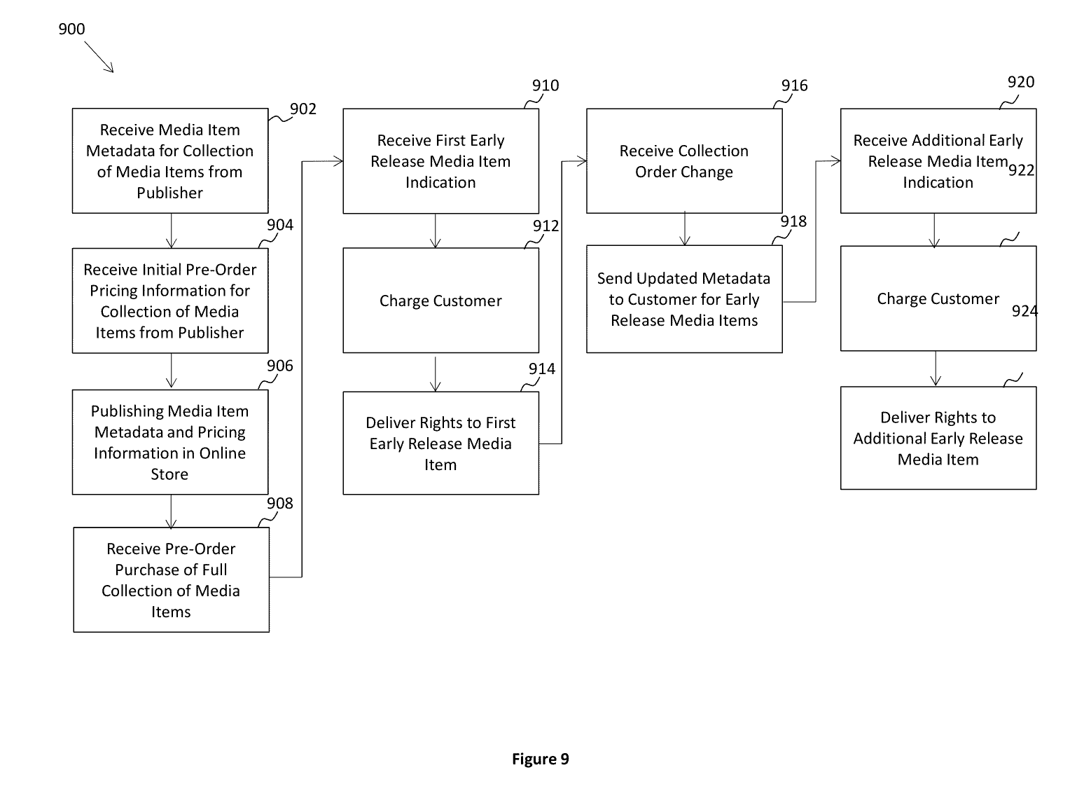

FIG. 9 illustrates an exemplary method 900 of rolling out a pre-order campaign. The method 900 begins with receiving, from the publisher of a collection of media items on pre-order, metadata for a collection of media items 902 and initial pre-order pricing information 904. Next, the collection is published in an online store along with the metadata and pricing information 906. Subsequently, the store receives a pre-order purchase of the full collection of media items from a customer 908. Accordingly, the customer is charged for any early released media items and will receive the early release items.

Next, an indication is received in the online store that a publisher has chosen to release a first early release media item from the collection 910. By virtue of ordering the full collection, the customer is automatically charged for the early release media item 912 and the online store delivers rights to the first early release media item 914.

The method 900 also involves receiving a change in the order of the media items in the collection from the publisher 916. Since the first early release media items was already delivered to the customer, the method 900 can involve sending updated metadata for the already delivered media item 918.

Additionally, the method 900 includes receiving an indication that a publisher has chosen to release an additional early release media item from the collection 920. Again, by virtue of ordering the full collection, the customer is automatically charged for the additional early release media item 922 and the online store delivers rights to the first early release media item 924.

Customer may want to know about changes in a pre-order campaign as the publishers make them. For example, customers anticipating the release of an album will become excited about an artist if the release date for the artist's album is moved closer. Indeed, it can be beneficial to an online store to take advantage of a customer's excitement by offering other similar items for sale, recording taste data, etc. Accordingly, some embodiments of the present technology involve a notification system for alerting customers when a publisher has changed the status of a pre-order collection of media items or has released a media item from the collection as an early release.

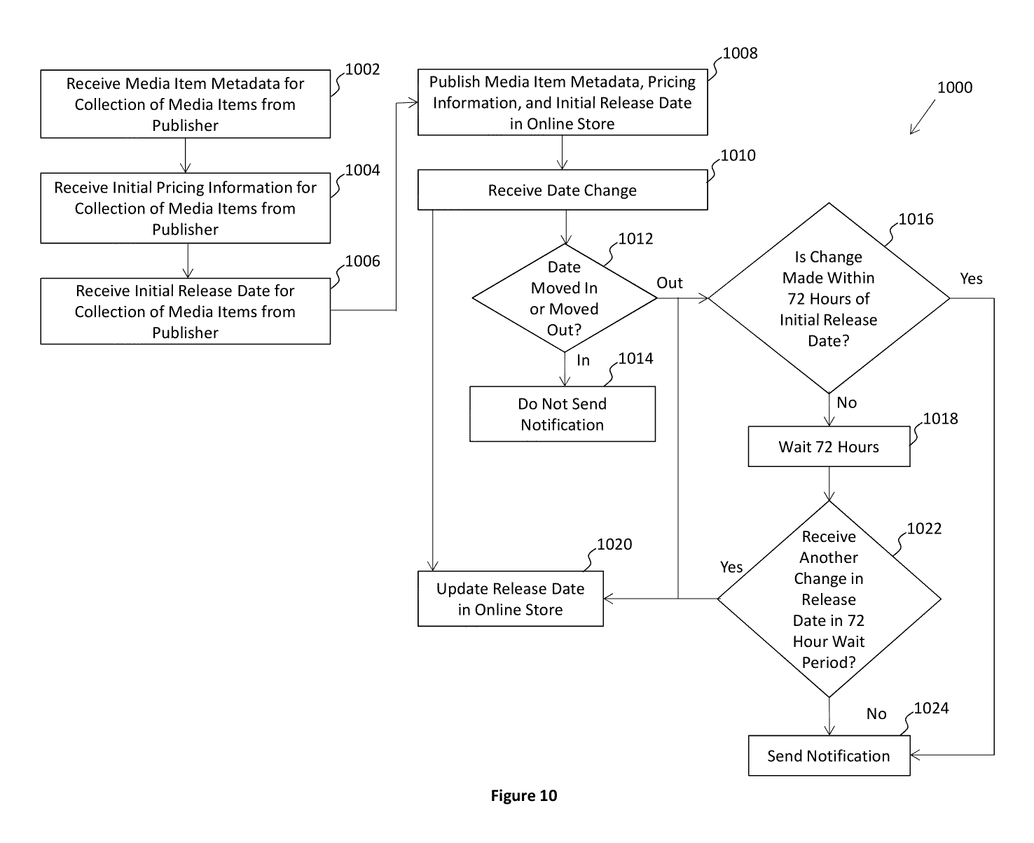

FIG. 10 illustrates a method 1000 for sending pre-order campaign notifications according to some embodiments of the present technology. The method 1000 begins with a media distribution platform receiving, from the publisher of a collection of media items on pre-order, metadata for a collection of media items 1002, initial pre-order pricing information 1004, and an initial release date 1006. Next, the collection is published in an online store along with the metadata, pricing, and initial release date 1008.

Subsequently, the media distribution platform receives a release date change indication from the publisher 1010 and determines 1012 whether the change moves the release date out past the initial release date or in sooner to the present. Additionally, the release date is updated in the online store 1020.

If the release date is moved in sooner, the method 1000 does not notify the customer 1014. Alternatively, if the release date out past the initial release date, the method 1000 further involves determining whether the change is being made within a given time period (i.e. seventy-two hours) of the initial release date 1016. If the change occurred within the given time period (i.e. seventy-two hours) of the initial release date, a notification is sent 1024; and, if not, the method 1000 waits a period of the given time period (i.e. seventy-two hours) 1018.

The method 1000 also involves determining whether an additional change in the release date was made during the seventy-two hour waiting period 1022. If so, the release date is updated in the online store 1020 and the method 1000 reiterates with determining whether the change is being made within the given time period (i.e. seventy-two hours) of the initial release date 1016. If not, a notification is sent 1024.

As explained above, according to some embodiments of the present technology, publishers can choose to release early-release media items from a pre-order collection in response to the media item receiving rapid and sometimes unexpected popularity. Additionally, the publishers can choose to schedule the early release of groups of media items and also schedule notifications sent to the customers.

As further explained above, some embodiments of the present technology involve the media distribution platform accepting a preorder request, taking payment information without charging the customer, and automatically charging the customer and downloading (unless a customer has cancelled the pre-order) the media items as they become available in the platform from the content provider. Some other embodiments involve providing customers with control over a pre-order and auto-download process. In some embodiments, the media distribution platform can be configured to provide users with options for scheduling pre-order purchases, automatic early release media item purchases, automatic early release media item downloads, and automatic full collection downloads based on factors such as time, budget, or other criteria. For example, a user can commit to purchasing a collection of pre-order collection to lock in a pre-order price but then pre-define a schedule for being charged for and downloading media items (possibly even after the collection is released) in order to spread the cost of the collection over time. Similarly, a customer can define a time-based budget that can be used to limit how much they are charged for any media items in a certain period of time and the media distribution platform can charge the customer and allow media item downloads over a more extended period of time to accommodate the customer's budget.

In some embodiments, in addition to a straightforward order for an entire collection of pre-order media items, the media distribution platform can also be configured to take a deposit less than an entire pre-order collection. For example, an online store can offer an album for pre-order at a price of $9.99 and a customer can commit to a $5.00 deposit. In this case, the customer can automatically receive any early release media items from the collection with the costs of those items being deducted from the $5.00 deposit. Additionally, the customer can receive a notification when the deposit amount has been reduced such that they will cease to receive additional early release media items or when the entire collection is about to be released so the customer can chose to pay the balance of the pre-order price of the collection to lock in that price before a post-release price increase. In the event that the customer cancels the pre-order, the amount of funds remaining from the deposit can be issued as store credit.

As explained above, publishing pre-order collections of media items at a lower price point than the release price and releasing early release media items can be a way to incentivize customer to purchase the entire collection of media items. Some embodiments of the present technology also involve incentivizing customers by using a pre-order price as a reward for other customer behaviors. Depending on purchase history, the system could have rules for reducing pre-order pricing to an older cheaper amount. For example, suppose that after the pre-order period has run out and an artist's album is released at a higher price, a customer user begins to purchase other media items released by the same artist but not on the newly released album. The system can reward the customer with an offer to purchase the newly released album at a pre-order price point if the customer purchases a threshold number of the artist's other media items.

Additionally, in some cases, a publisher can release two versions of a collection of media items. For example, music publishers can release a basic version of an album and a deluxe version having additional bonus tracks. Accordingly, some embodiments of the present technology involve honor pricing for upgrading to a deluxe version of a collection of media items.

In some cases, a publisher will simultaneously schedule the release date for a deluxe version of a collection of media items and the release date of a basic version with the deluxe version being released at a later time. In these cases, a customer can pre-order the deluxe version, get charged for the basic version and receive the basic version upon its release, and get charged for and receive the bonus content in the deluxe version at the later release date with the total price charged equaling the pre-order price of the deluxe version.

In some other cases, a deluxe version of a collection of media items with bonus tracks is not scheduled for release until a much later time, i.e. a remastered album with previously unreleased studio tracks. In these cases, an honor pricing scheme can determine that a previously purchased album has a threshold similarity to the remastered album, determine how much a customer paid for the basic, album, and charge only the difference between the already charged amount and the price of the deluxe version before delivering the bonus tracks. Additionally, the deluxe version tracks (i.e. remastered tracks) can replace the prior version, be downloaded and stored alongside the prior versions, or remain un-downloaded in favor of the customer retaining the prior (i.e. vintage) version of the tracks. In some cases, the customer can be charged an upgrade fee to obtain the deluxe version of the media items.

A publisher can release a collection of media items with one or more media item only being available to customers who purchase the entire collection, i.e. “album only.” Accordingly, some embodiments of the present technology involve a media distribution platform configured to allow publisher the opportunity to change the “collection only” status of media items in a collection.

Although many of the examples described herein involve pre-ordering collections of digital music, it will be readily apparent to those with ordinary skill in the art having the benefit of this disclosure that the present technology can be used to manage pre-orders for collections of television shows, movies, magazines, books, podcasts, etc.

### Computing Environments

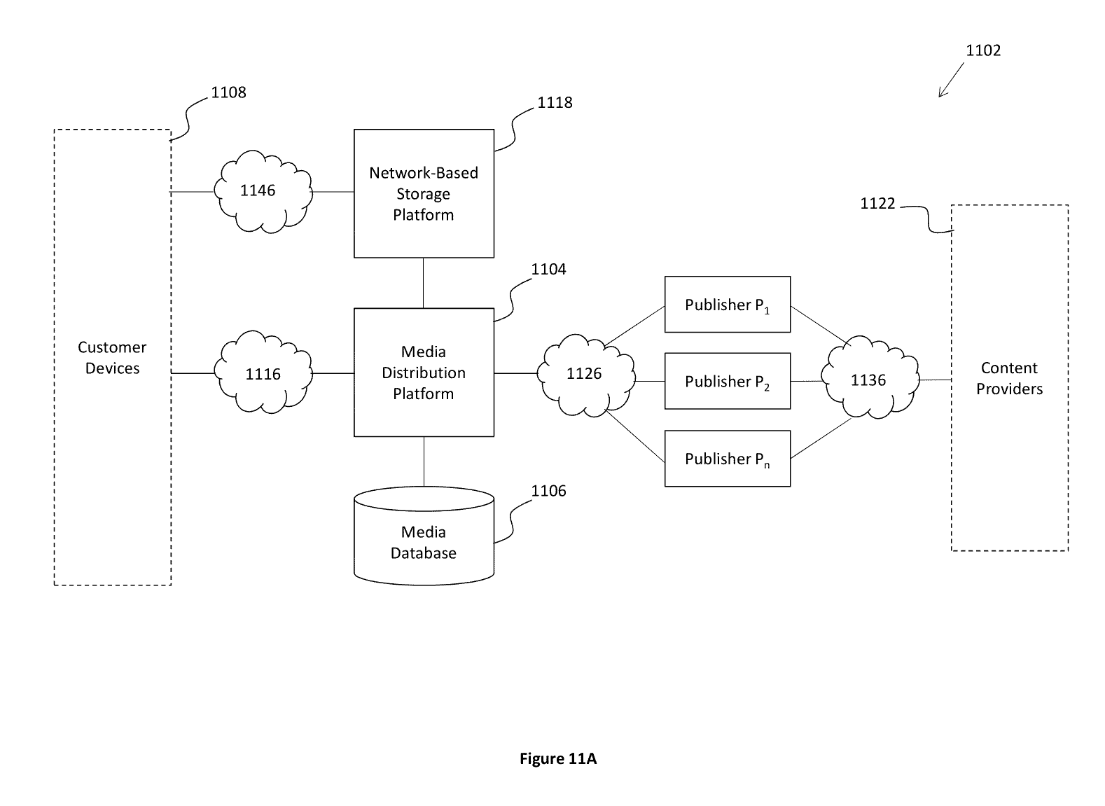

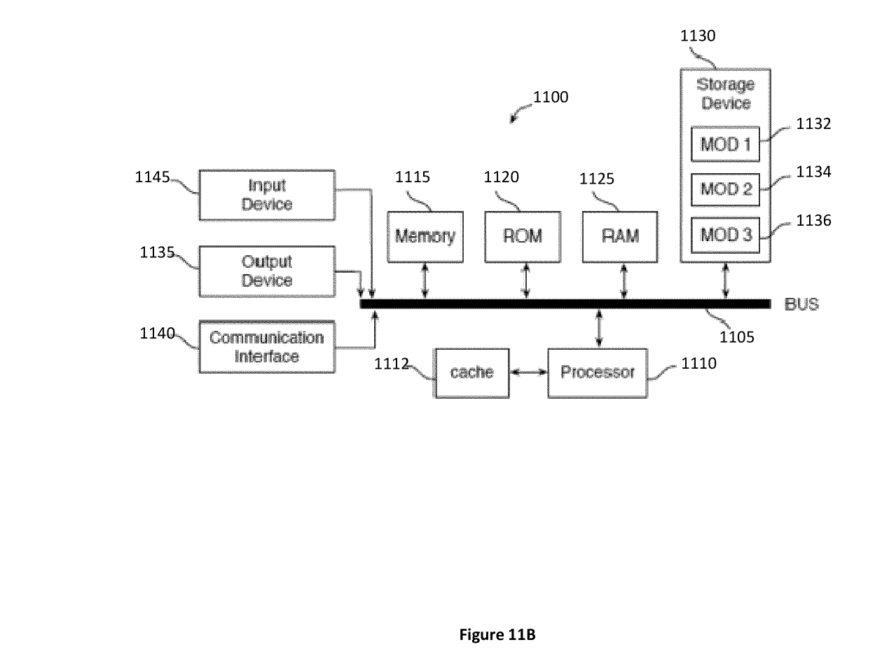

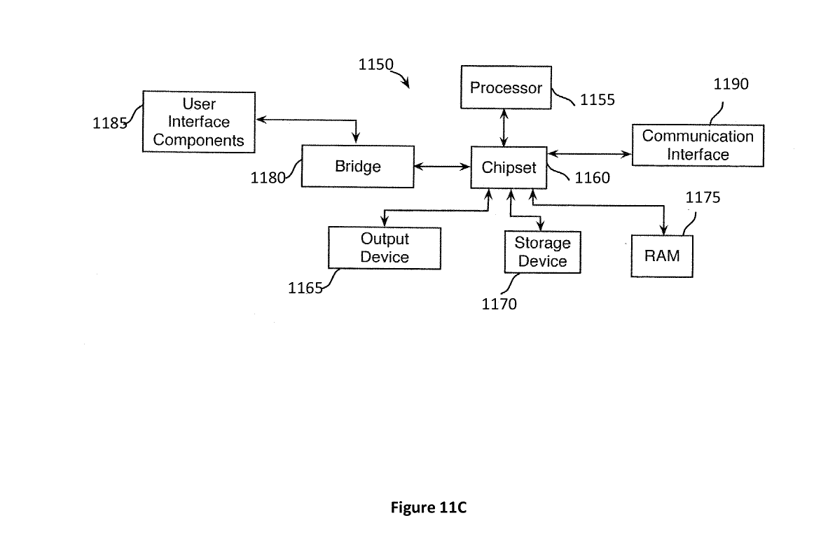

The present technology can be implemented in a distributed computing environment with customers, publishers, and content providers networked together via a media distribution platform. FIG. 11A illustrates an application distribution system 1102 according to some embodiments of the present technology.

The application distribution system 1102 can include a media distribution platform 1104 such as the ITUNES, available from Apple Inc. of Cupertino, Calif. As such, the media distribution platform 1104 can be configured to store, sell, rent, stream any type of digital media product such as music, movies, television shows, user-generated videos, digital books, podcasts, applications, magazines, photos, artwork, etc.

The media distribution platform 1104 can be operatively coupled with a media database 1106 and with a plurality of customer devices 1108 via a network 1116. It will be appreciated that the customer devices 1108 can be any computing device known in the art, whether a desktop computer, laptop, smart phone, tablet, etc. Further, these devices can be portable or in a fixed location.

Additionally, one ore more customer device in the plurality of customer devices 1108, the media distribution platform 1104, or combinations thereof can be operatively coupled, via network 1146, with a network-based storage platform 1118, such as ICLOUD, available from Apple Inc. of Cupertino, Calif.

The media distribution platform 1104 can also be operatively coupled with a plurality of publishers P₁, P₂, . . . , Pₙ via a network 1126. Likewise, the publishers P₁, P₂, . . . , Pₙ can be operatively coupled with one or more of a plurality of content providers 1122 via a network 1136.

In various embodiments, the networks 1116, 1126, 1136, and 1146 can comprise the same network or different networks and can comprise computer networks, telephone networks, Ethernet, local area networks, wired networks, wireless networks, etc.

FIG. 11B and FIG. 11C illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 11B illustrates a conventional system bus computing system architecture 1100 wherein the components of the system are in electrical communication with each other using a bus 1105. Exemplary system 1100 includes a processing unit (CPU or processor) 1110 and a system bus 1105 that couples various system components including the system memory 1115, such as read only memory (ROM) 1120 and random access memory (RAM) 1125, to the processor 1110. The system 1100 can include a cache of high-speed memory connected directly with, in close proximity to, or integrated as part of the processor 1110. The system 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other system memory 1115 may be available for use as well. The memory 1115 can include multiple different types of memory with different performance characteristics. The processor 1110 can include any general purpose processor and a hardware module or software module, such as module 1 1132, module 2 1134, and module 3 1136 stored in storage device 1130, configured to control the processor 1110 as well as a special-purpose processor where software instructions are incorporated into the actual processor design. The processor 1110 may essentially be a completely self-contained computing system, containing multiple cores or processors, a bus, memory controller, cache, etc. A multi-core processor may be symmetric or asymmetric.

To enable user interaction with the computing device 1100, an input device 1145 can represent any number of input mechanisms, such as a microphone for speech, a touch-sensitive screen for gesture or graphical input, keyboard, mouse, motion input, speech and so forth. An output device 1135 can also be one or more of a number of output mechanisms known to those of skill in the art. In some instances, multimodal systems can enable a user to provide multiple types of input to communicate with the computing device 1100. The communications interface 1140 can generally govern and manage the user input and system output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof.

The storage device 1130 can include software modules 1132, 1134, 1136 for controlling the processor 1110. Other hardware or software modules are contemplated. The storage device 1130 can be connected to the system bus 1105. In one aspect, a hardware module that performs a particular function can include the software component stored in a computer-readable medium in connection with the necessary hardware components, such as the processor 1110, bus 1105, display 1135, and so forth, to carry out the function.

FIG. 11C illustrates a computer system 1150 having a chipset architecture that can be used in executing the described method and generating and displaying a graphical user interface (GUI). Computer system 1150 is an example of computer hardware, software, and firmware that can be used to implement the disclosed technology. System 850 can include a processor 1155, representative of any number of physically and/or logically distinct resources capable of executing software, firmware, and hardware configured to perform identified computations. Processor 1155 can communicate with a chipset 860 that can control input to and output from processor 1155. In this example, chipset 1160 outputs information to output 1165, such as a display, and can read and write information to storage device 1170, which can include magnetic media, and solid state media, for example. Chipset 1160 can also read data from and write data to RAM 1175. A bridge 1180 for interfacing with a variety of user interface components 1185 can be provided for interfacing with chipset 1160. Such user interface components 1185 can include a keyboard, a microphone, touch detection and processing circuitry, a pointing device, such as a mouse, and so on. In general, inputs to system 1150 can come from any of a variety of sources, machine generated and/or human generated.

Chipset 1160 can also interface with one or more communication interfaces 1190 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 1155 analyzing data stored in storage 1170 or 1175. Further, the machine can receive inputs from a user via user interface components 1185 and execute appropriate functions, such as browsing functions by interpreting these inputs using processor 1155.

It can be appreciated that exemplary systems 800 and 850 can have more than one processor 1110 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

We claim:

1. A media distribution platform comprising:
a media database configured to store media items and media item information for a plurality of media items;
an account database configured to store account information for a plurality of customers;
an online store management module configured to:
receive, from a media provider, information describing a collection of media items and a schedule describing when media items in the collection of media items will be actually released;
receive, from the media provider, changes to the schedule.

2. The media distribution platform of claim 1, wherein the online management module is configured to:
receive an order from a customer for one or more media items in the collection of media items; and
charge the customer for the order in an amount dependent upon the schedule when the purchase order was submitted.

3. The media distribution platform of claim 1, wherein the online management module is configured to receive, from the media provider, an indication that a media item from the collection of media items should be offered through the online store as an early release media item.

4. The media distribution platform of claim 3, wherein the online management module is configured to receive, from the media provider subsequent to the indication, an additional indication that an additional media item from the collection of media items should be offered through the online store as an additional early release media item.

5. The media distribution platform of claim 1, wherein the online management module is configured to receive, in the schedule, a range of dates describing a pre-order period that the collection of media items will be available for pre-order.

6. The media distribution platform of claim 1, wherein the online management module is configured to receive, in the schedule, an original release date describing when the collection of media items will be released.

7. The media distribution platform of claim 6, wherein the online management module is configured to receive, as a change to the schedule, a modified release date describing when the collection of media items will be released.

8. The media distribution platform of claim 7, wherein the online management module is configured to determine that the modified release date has been moved further into the future than the original release date.

9. The media distribution platform of claim 8, wherein the online management module is configured to:
determine that the modified release date was received less than a threshold period of time before the original release date; and
send a notification to a customer who ordered the collection of media items in the pre-order period.

10. The media distribution platform of claim 8, wherein the online management module is configured to:
determine that the modified release date was received after a threshold period of time before the original release date; and
begin to toll a waiting period.

11. The media distribution platform of claim 10, wherein the online management module is configured to:
determine that a subsequent change to the modified release date has not been received during the waiting period; and
send a notification to a customer who ordered the collection of media items in the pre-order period.

12. A computer-implemented method comprising:
receiving, from a media provider, information describing a collection of media items available for pre-order during a pre-order period and an initial release date and a schedule describing when media items in the collection of media items will be actually released;
receiving an order from a customer for one or more media items in the collection of media items;
receiving, from the media provider, changes to the schedule; and
charging the customer for the order in an amount dependent upon the schedule when the purchase order was submitted.

13. The method of claim 12, further comprising:
receiving, from the media provider, an indication that a media item from the collection of media items should be offered through the online store as an early release media item; and
receiving, from the media provider subsequent to the indication, an additional indication that an additional media item from the collection of media items should be offered through the online store as an additional early release media item.

14. The method of claim 13, further comprising:
receiving, as a change to the schedule, a modified release date describing when the collection of media items will be released; and
determining that the modified release date has been moved further into the future than the original release date.

15. The method of claim 14, further comprising:
determining that the modified release date was received less than a threshold period of time before the original release date; and
sending a notification to a customer who ordered the collection of media items in the pre-order period.

16. The method of claim 14, further comprising:
determining that the modified release date was received after a threshold period of time before the original release date;
beginning to toll a waiting period;
determining that a subsequent change to the modified release date has not been received during the waiting period; and
sending a notification to a customer who ordered the collection of media items in the pre-order period.

17. A non-transitory computer-readable storage medium comprising:
a medium configured to store computer-readable instructions thereon; and
the computer-readable instructions that, when executed by a processing device cause the processing device to perform a method, comprising:
receiving, from a media provider, information describing a collection of media items available for pre-order during a pre-order period and an initial release date describing when media items in the collection of media items will be actually released;
receiving an order from a customer for one or more media items in the collection of media items;
receiving, from the media provider, changes to the schedule; and
charging the customer for the order in an amount dependent upon the schedule when the purchase order was submitted.

18. The non-transitory computer-readable storage medium of claim 17, the instructions further causing the processing device to perform the steps of:
receiving, from the media provider, an indication that a media item from the collection of media items should be offered through the online store as an early release media item; and
receiving, from the media provider subsequent to the indication, an additional indication that an additional media item from the collection of media items should be offered through the online store as an additional early release media item.

19. The non-transitory computer-readable storage medium of claim 17, the instructions further causing the processing device to perform the steps of:
receiving, as a change to the schedule, a modified release date describing when the collection of media items will be released; and
determining that the modified release date has been moved further into the future than the original release date;
determining that the modified release date was received less than a threshold period of time before the original release date; and
sending a notification to a customer who ordered the collection of media items in the pre-order period.

20. The non-transitory computer-readable storage medium of claim 17, the instructions further causing the processing device to perform the steps of:
receiving, as a change to the schedule, a modified release date describing when the collection of media items will be released; and
determining that the modified release date has been moved further into the future than the original release date;
determining that the modified release date was received after a threshold period of time before the original release date;
beginning to toll a waiting period;
determining that a subsequent change to the modified release date has not been received during the waiting period; and
sending a notification to a customer who ordered the collection of media items in the pre-order period.
